(19) United States
(12) Patent Application Publication
(10) Pub. No.: US 2002/0133477 A1
(43) Pub. Date: Sep. 19, 2002

(54) Method for profile-based notice and broadcast of multimedia content

(76) Inventor: Glenn Abel, Plano, TX (US)

Correspondence Address: Laurence E. Stein, Esq., Patton Boggs LLP, 2550 M Street, N.W., Washington, DC, 20037, US

(21) Appl. No.: 09/797,874

(22) Filed: Mar. 5, 2001

(51) Int. Cl. G06F 7/00

(52) U.S. Cl. 707/1

(57) ABSTRACT

An electronic message based advance notification system for delivery of content relating to user selected areas of interest. A user profile database is created, each profile having a user identifier, a data identifying items or subjects of interest, and a user notice descriptor identifying the address and media for messaging to the user. A broadcast request, via e-mail or web form, having a content body data and a notice descriptor data is received. A notice is transmitted to users having a profile matching the notice descriptor, the notice identifying a subsequent broadcast by subject, source address, and time for broadcast. The subsequent broadcast is then made available at the indicated time and source address.

### FIELD OF THE INVENTION

This invention relates generally to the field of multimedia broadcasting and, more particularly, to a method and apparatus for criteria-based notification of future broadcast events and subsequent broadcasting or accessing of same.

### DESCRIPTION OF THE RELATED ART

World wide data transfer and distribution networks, particularly the Internet and the World Wide Web, are making accessible an ever-increasing amount of multimedia information, from an ever-increasing number of information sources. In addition to increasing the quantity and availability of information, the Internet and other wide-area distribution networks have substantially reduced the time lag between the generation of the information and its broadcast or distribution world wide. The reduced time lag is becoming more important, as professionals are increasingly relying on such up-to-the-minute information for making time critical business decisions. In addition, industry and government frequently incorporated into their marketing and public relations process the fact that their generated information may, in matter of minutes, be known to millions.

For these and other reasons, the value of information transferable over the Internet, both to the entities that generate it, and to the persons that receive it, is increasingly time sensitive. A streaming data broadcast of a White House press conference or a high-profile court proceeding will have considerably greater value at the time of the event than it would, for example, just two hours later. A press release by a major corporation, having significant impact on the stock value of the corporation, has an exponentially decreasing value over time to persons who trade in the stock. In addition to the time value, the availability of such information, at least in its original unedited form, may be time limited.

Due to the large number and wide variety of information content providers, the task of monitoring the newly updated content from each has become difficult. Even if the identity of the content provider is known, the user must constantly monitor the provider's web site, or have a continual connection which downloads and stores every streaming content that the provider broadcasts. This is frequently impractical, and becomes more so as the number of content providers in which the user has interest increases. Further, the present inventor has identified that, related to this time sensitivity, the user may frequently benefit, or be more satisfied, if the content can be viewed from the beginning, without missing that which transpired between the time he or she learned of the streaming data and the time access was available. Still further, as identified by the present inventor, a considerable uninterrupted block of the user's time may be required for viewing the streaming content. Advance notice is necessary to permit the user to accommodate his or her schedule accordingly.

The present inventor has identified, however, that there are no known current systems that monitor and provide effective, targeted notice of upcoming broadcasts of specific news and business information, thereby keeping users apprised of new information as well as giving them adequate time to connect to and receive a full streaming data content from the very beginning.

U.S. Pat. No. 6,119,163, (“the '631 patent) describes a control mechanism directed to users who are to receive real-time information, including audio, video, graphics, text and other type of information that can be transmitted over a digital network. With a system according to the '631 patent a user must know beforehand that the real-time even is to occur. The user also must know the source, e.g., the Uniform Resource Locator (URL), for the real time broadcast stream. The '631 patent does not teach identification of users, or subscribers, who would likely be interested in the real-time event to occur, and then provide advance notification alert to those users.

U.S. Pat. No. 5,995,597 (“the '597 patent”) describes a mail program running on a host computer receiving incoming electronic messages. According to the '597's description, an authorized user manually queries a user data profile and generates a series of e-mail messages and pager messages which are formatted and distributed based upon the user profile and data filtered from the incoming message. The '597 patent describes its method as allowing an e-mail recipient to be promptly notified via pager of the receipt of any mail message. Then, in accordance with the '597's description, the user receives a complete copy of the message, a simple message notice, or can have the message delayed until expiration of a message hold period, the specific options depending upon the message typed. The selection of end receivers is manual. Further, the method according to the '597 description notifies the recipient of receipt of an item, without notification of a future broadcast, and therefore does not provide the recipient an opportunity to be available for receipt of the actual item at the instant it becomes available should he or she chose to do so.

U.S. Pat. No. 5,937,162 (“the '162 patent”) discloses an e-mail “newspaper” delivery system having, for each customer, a personal configuration file containing the information resources that the customer would like e-mailed to his or her desktop. The configuration file is customizable, allowing the end-user some control over the content, format, and timing of the delivered e-mails. The system of the '162 patent, however, provides distribution using time based rules as in the case of a daily, hourly or weekly newsletter. The '162 patent does not address or identify an advance delivery notification, based on a future event, thereby allowing the end receiver to tune in or join a broadcast stream prior to the event occurring.

U.S. Pat. No. 5,893,091 (“the '091 patent”)discloses a method for noticing and distributing information over a computer network based on Boolean keyword term searching term of the content. The '091 system does not have any content filter, content identifier, or category filter, or selector of recipients, other than the Boolean operator search. Accordingly, if a user of the '091 system enters, for example, “IBM”, the system will simply notify him or her of every information in which the word IBM appears.

### SUMMARY OF THE INVENTION

In view of the above-identified shortcomings in the present art of information gathering and dissemination, an object of the present invention is to provide a user profile-based notification to users concerning upcoming broadcasts of information.

A further object of the invention is to channel streaming data broadcasts from a plurality of different sources through a common formatting and delay channel, generate profile-based advance notification based on content and category, and provide subsequent broadcast in accordance with the advance notification.

A first embodiment of the invention comprises a data network, with a user profile data storage device, a user data entry device, a submitter data entry device, and a general purpose programmable processing resource connected to the data network.

A first method according to the invention forms a user profile database having a plurality of user profile records, each user profile record having a user identifier data, a user notification descriptor data, and a user key word data. The user profile database is formed by receiving and storing a plurality of user profile records at the user profile data storage device. Next, a general purpose programmable processing resource, such as a web server, receives a broadcast request data having a notification header and a broadcast content data, the notification header having a submitter key word data and a broadcast time data. The method then compares the submitter key word data to the user key word data of the stored plurality of user profile records and, based on the comparing, identifies a matching user profile record. Next, a notification data is generated based on the comparing, the notification data having a notice subject data representing a result of the comparing, and having a notice broadcast time data corresponding to said broadcast time data. The method then transmits, at a notice time, the notification data, the transmitting based on the user notification descriptor data of the matching user profile record. The notice time is based a predetermined notice advance data and on the broadcast time data. Next, the method broadcasts at least one public broadcast data corresponding to the broadcast content data, at a broadcast time subsequent to the notice time, the broadcast time corresponding to the broadcast time data in the notification header of the first broadcast stream data.

A second method is in accordance with the first method, and further generates a broadcast source address data, and generates the notification signal to include a notice source address data based on the broadcast source address data. The method broadcasts the at least one public broadcast data on a network having an addressable source protocol, the broadcast based on the protocol and the broadcast source address data.

Another method is in accordance with the first and second methods, and further generates an alternative broadcast source address data, and generates the notification signal to include a notice source address data and alternative notice source address data, based on the broadcast source address data and the alternative broadcast source address data, respectively. This method broadcasts the at least one public broadcast data on a primary network and on an alternative network. The broadcast on the primary network corresponds to the broadcast source address data, and the broadcast on the alternative network corresponds to the alternative broadcast source address data.

A still further method is in accordance with the above methods, and includes a reference pointer data within the broadcast content data. This method includes a step of retrieving a data corresponding to the reference pointer data, and including the retrieved data in the at least one public broadcast data.

A still further method according to the above methods detects a time at which the step of receiving the broadcast request data receives the request, and compares the detected time to the broadcast time data. A validation data is then generated based on a result of the comparing and on the predetermined notice advance time data.

A further method according to the above methods receives with at least one of the user key words a notification timing data representing a user preference for the timing of the notification signal with respect to the broadcast time data.

### BRIEF DESCRIPTION OF THE DRAWINGS

The foregoing and other objects, aspects, and advantages will be better understood from the following description of preferred embodiments of the invention with reference to the drawings, in which:

FIG. 1 is a high level functional block diagram of an example system in accordance with the invention;

FIG. 2 is a flow chart of a method for profile-based notification of broadcast in accordance with the invention, in reference to the example system of FIG. 1;

FIG. 3 is a flow chart of an example of the user registration step within the method of FIG. 2; and

FIG. 4 is an example user data entry form for a user registration step within the example method of FIG. 2.

### DETAILED DESCRIPTION OF THE INVENTION

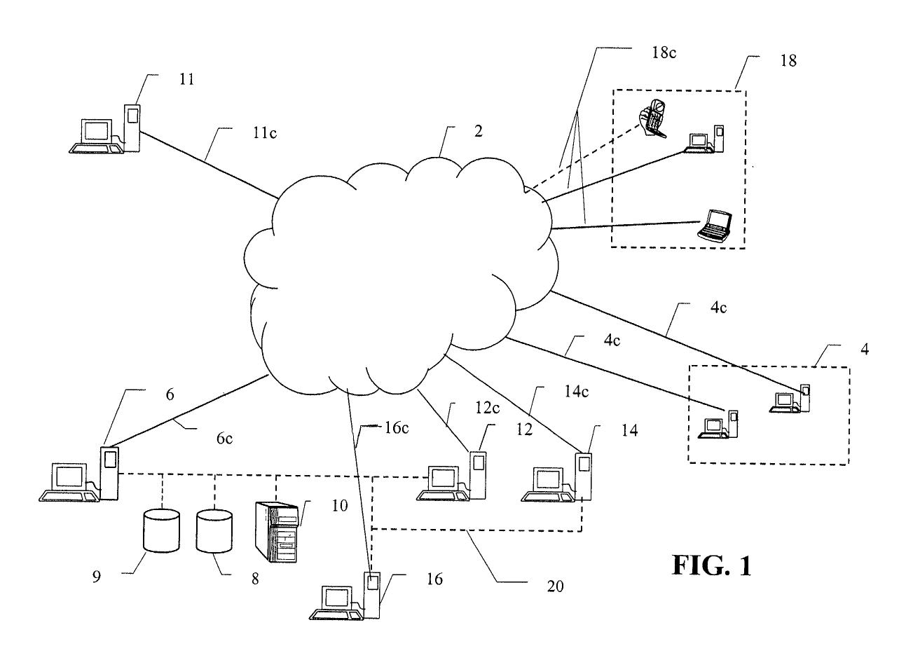

Referring to FIG. 1, an example system diagram for carrying out the described method of this invention will be described. The FIG. 1 example system is blocked according to functions and does not explicitly limit the various hardware system implementations for performing the depicted functions. On the contrary, as will be understood by one of reasonable skill in the relevant art of commercial data transmission, processing, networking and storage, a plurality of the FIG. 1 depicted functions may, in accordance with conventional design practices, be performed by one physical unit, while other functions may be distributed over, or mirrored by, a plurality of physical units.

The FIG. 1 example system comprises, as functional blocks, a wide area network 2, such as the Internet, a plurality of remote user data interface units 4 with associated Internet, or network, connection means 4c, a central user data interface 6 connected to the network 2 by an associated connection means 5c and to a PROFILE DATABASE 8 and a general purpose programmable processing resource 10. The FIG. 1 example system further comprises a plurality of remote submitter data interface units 11, a central submitter data interface 12, a broadcast resource 14, a content production resource 16, and a plurality of user receiving units 18. The FIG. 1 example system shows each of the items 11, 12, 14, 16 and 18 connected to the network or Internet 2 by associated connection means 11c, 12c, 14c, 16c, and 18c. The respective connection means are readily selected from among the various commercially available systems and methods, based on well-known selected criteria of cost, reliability and capacity. The FIG. 1 example system further shows the central submitter data interface 12, the broadcast resource 14, and the content production resource 16 connected to one another by a connection path 20 which is alternate to the network or Internet 2. As will be understood by one of ordinary skill in the art, connection path 20 may be a typical Ethernet Local Area Network. Further, if the units connected by path 20 are implemented by a single server then path 20 is not necessary. Accordingly, it should also be understood that the connection path 20 shown in FIG. 1 is does not constrain or define the hardware system architectures for implementing the functions of the respective units

An example remote user data interface unit 4 is a standard personal computer such as, for example, a Dell® Optiplex GX1, having an Intel Pentium III® or equivalent processor, a 56 kbyte/sec modem, and running under the Windows® NT, Windows 2000® or equivalent operating system. Example user connection lines 4c are plain old telephone system (POTS) lines connecting to the Internet 2 by way of an Internet Service Provider (not shown) such as, for example, America On Line®.

An example central user data interface 6 is a web server, such as a Sun® E250 web server (not shown) running under the Solaris® or equivalent UNIX, or Windows® server software. Example software for carrying out the web server operations is Netscape® Enterprise Server, or equivalent. Alternatively, the central user interface 6 is a mail server, such as a Dell Poweredge® 2400 running, for example, Windows Exchange or equivalent. Still further, the central user data interface 6 may contain both a mail server and a web server, connected by a router (not shown) to the USER PROFILE DATABASE 8.

An example hardware for storing and maintaining the USER PROFILE DATABASE 8 is a Sun® E3500, running Oracle® 8i or equivalent, connected to a RAID (Redundant Array of Independent Disks) storage array. The USER PROFILE DATABASE 8 may be replicated at multiple mirror sites physically remote from one another, connected to one another over the Internet or over a wide area Intranet, synchronized using readily available commercial software applications known to persons skilled in the art.

The general purpose programmable processing resource 10 may be a centralized or a distributed function and, for example, may be one or more central processing units (CPUs) within the hardware system(s) implementing the central user data interface 6, or within the hardware system(s) storing the USER PROFILE DATABASE 8, or implementing other described units of FIG. 1.

An example of the remote submitter data interface unit 11 is a conventional personal computer having Internet access means, such as the example remote user data interface means 4 described above. Alternatively, the remote submitter data interface unit 11 may be a client computer (not shown) or thin client terminal (not shown) connected to a Windows NT® or Windows 2000® based corporate network (not shown), connected via a router and web server (not shown) to the Internet. Still further, the submitter remote data interface unit 11 may be a third party resource interposed between an actual submitting party and the central submitter data interface 12.

The central submitter data interface 12, notice broadcast resource 14 and content broadcast resource 16 may be, or may include, the same hardware system that is used for the remote user data interface 4. The notice broadcast unit 14 may also include automated pager and voice messaging functions.

The content production resource 16 may be a general purpose programmable computer, such as the example remote user data interface means 4 described above, connected by way of a conventional network to the central submitter data interface means 12. As will be understood from this description, the content production resource 16 reads, or provides means for manually reading, files and pointers, such as hyperlinks, within files received from submitters, and retrieving the information corresponding to the pointers and hyperlinks, assembling and formatting the data for transmission as, for example, a streaming data broadcast over the Internet. As a means for performing such functions the content production resource 16 is shown in FIG. 1 as connected to the network 2. A conventional personal computer, or a distributed resource of such conventional computers networked by, for example, a Windows NT client-server arrangement, and having Internet access, would implement the content production resource 16.

Referring to FIG. 1, example user receipt units 18 include the personal computer example described for the remote user data interface 4, in addition to hand-held web access devices such as Palm Pilot® and Blueberry®, as well as cell phones and pagers with text receiving capabilities. Typically, a user may use the same user receiving device 18 for receiving the notice signals described for this invention and he or she uses for receiving the described content broadcasts. However, it is contemplated that a user may receive notice of an upcoming broadcast on, for example, a pager with text receiving capability, and then locate a computer having Internet access to receive the noticed broadcast.

The above-described example hardware systems are for purposes of example only. Other commercially available hardware and related control software is readily identified and configured for performing the methods described by this invention by persons of ordinary skill in the art. In addition, it should be understood that the FIG. 1 system blocks are according to functions, and do not necessarily reflect or constrain the hardware architecture for implementing the system. As will be understood from this description, a plurality of the depicted functions may be performed by one physical unit, while other functions may be distributed over, or mirrored by, a plurality of physical units. For example, it is contemplated that the central user data interface 6, the programmable computational resource 10, and the subscriber central data interface 12 may be implemented by a single web server, such as the example described above for the central user data interface 6

### Constructing/Editing the USER PROFILE DATABASE

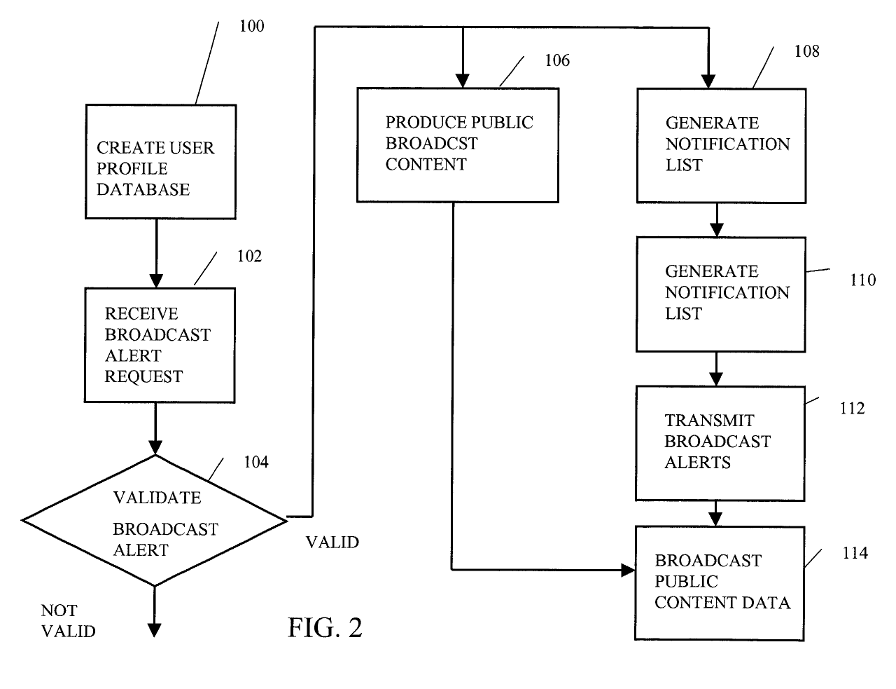

Referring to FIG. 2, a general method according to the invention begins at step 100 by constructing the USER PROFILE DATABASE 8. The USER PROFILE DATABASE consists of a plurality of USER PROFILE RECORDs, each record having a USER ID, which is an identifier unique to the user and, optionally, a USER SECONDARY DATA, which identifies other information about the user, such as the company he or she works for. The USER PROFILE RECORDs include a PROFILE ITEM list of, for example, companies, for which the user wishes advance notice of upcoming broadcast from, or of broadcasts containing information about, and a USER CONTACT DATA identifying the means by which the user is to be contacted. The USER PROFILE LIST may also contain a PROFILE SECONDARY ITEM list of items having a lower interest value to the user.

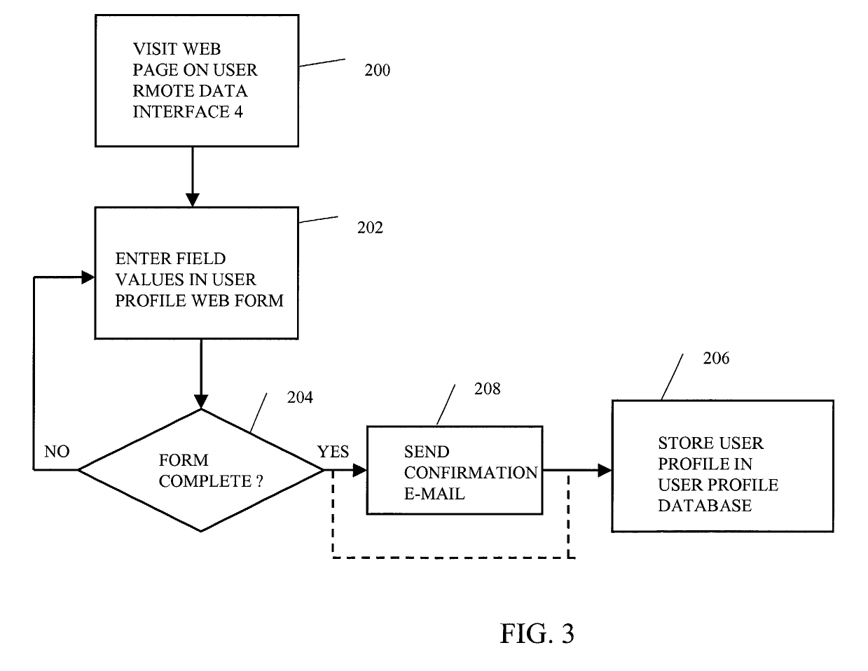

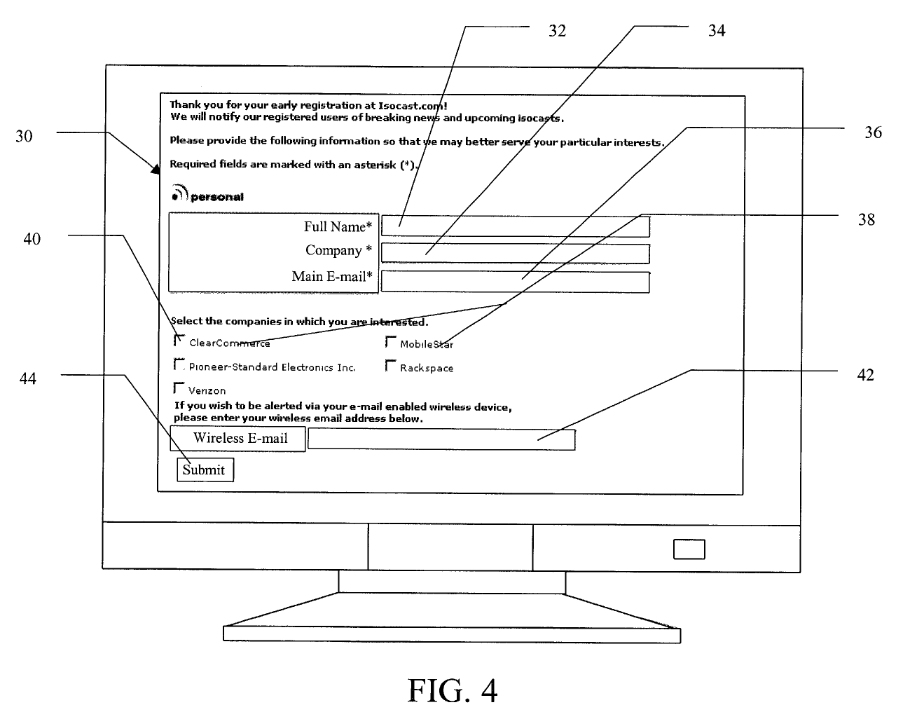

The USER PROFILE DATABASE 8 is constructed by users accessing and registering, by filling out data entry forms or other interface means, using one or more of a plurality of known or contemplated methods and media for public access to remote databases. An example method for carrying out step 100 is described further below in reference to FIGS. 3 and 4.

Concurrent with the user first time entries, or registrations, the USER PROFILE DATABASE 8 is continually updated by the users retrieving and editing their records using, for example, known methods of password-based access. The editing operation is substantially identical to the first-time user registration described above, except that the user may have the option of entering new information into a subset of the above-identified fields in the registration form. The issuance of the password is not described but may, for example, be in accordance with the existing well-known method wherein the user enters a new user identification and a corresponding password. The password is entered twice into two separate fields. If the two field entries match, the system searches its database, i.e., the USER PROFILE DATABASE 8, to determine if the user identification is unique. If the user identification is unique, the identification and password combination are assigned to the user. The user then, using an EDIT button (not shown), uses the identification and password to retrieve and edit his USER PROFILE.

### Receiving a BROADCAST ALERT REQUEST

Referring to FIG. 2, after step 100 establishes the USER PROFILE DATABASE, the method proceeds to step 102 where the central submitter data interface 12 receives, from the remote submitter data interface 11, a BROADCAST ALERT REQUEST for a public broadcast in accordance with the same. The BROADCAST ALERT REQUEST contains an ALERT DATA and a CONTENT DATA. The ALERT DATA includes an INTEREST ITEMS field, identifying items of interest contained in the CONTENT DATA, and contains a BROADCAST TIME DATA. The BROADCAST TIME DATA identifies the requested time for a broadcast of information contained in the CONTENT DATA.

The INTEREST ITEMS may, optionally, be further defined as PRIMARY ITEMS and SECONDARY ITEMS. In addition, the ALERT DATA may contain a BROADCAST TYPE data identifying the broadcast as, for example, a news item, stock value update, sports score, or Securities and Exchange Commission (“SEC”) report. Other data may, depending on the choice at time of implementation, include the format, expected length, and other information concerning the requested public broadcast.

Example means and formats of the ALERT DATA include a formatted message with the text field, or within a first attachment to an e-mail. Example formats for the CONTENT DATA include Microsoft Word®, HTML and XML, the CONTENT DATA being a second attachment to the e-mail. The CONTENT DATA may also contain video files, which may consist of formats including, for example, MPEG, Real Media® and *.avi. In addition, the CONTENT DATA may contain hyperlinks to other web sites or descriptors for linking to additional content. If the CONTENT DATA contains hyperlinks or other references to additional data the CONTENT PRODUCTION step 104, described below, will receive that information and combine it into the PUBLIC BROADCAST CONTENT.

An example submission step 102 is as follows

PRIMARY ITEM=Submitter, which is the primary company the mentioned in the release. Example name=XYZ Co.

SECONDARY ITEM=other companies mentioned in the release.

TYPE=Press Release. Other values may be “News Item”, “Stock Value”, “Sports Score”, SEC Notice.

BROADCAST TIME=the real time of public release.

### Validating the BROADCAST ALERT REQUEST

Next, at step 104, a preferred method according to this invention validates the BROADCAST ALERT REQUEST based on a preset NOTICE ADVANCE value. The NOTICE ADVANCE value is the number of minutes prior to the BROADCAST TIME that the method must transmit the BROADCAST ALERT. The NOTICE ADVANCE VALUE is selected to allow the user time, after receiving the BROADCAST ALERT, to initiate a connection with, for example, the Internet, using a user receiving unit 18. In such a case the user would connect to the broadcast based on an embedded Uniform Resource Locator (URL) identified in the BROADCAST ALERT, and receive the encoded event item consisting of video, audio, graphic and advertising related content. In addition, the user may connect at a later time and receive the content via electronic message archive or in printed form either from a web server or in electronic message formats.

The validation at step 104 is as follows: The email BROADCAST REQUEST message is received by the mail server (not shown) of the central submitter data interface 11, with the BROADCAST CONTENT DATA having the body of the press release. The BROADCAST REQUEST is moved to the general programmable processor resource 10 which, at step 104, validates the algorithm by subtracting the time required to process the information (determined by the particular system specifications and its current processing load) from the present time to determine if there is adequate time for transmitting the BROADCAST ALERT.

As an example, the NOTICE ADVANCE being preset to fifteen minutes means that the BROADCAST ALERT must be sent fifteen minutes before the BROADCAST TIME. In other words, if the BROADCAST TIME is Jan. 10, 2001 at 12:30 PM the BROADCAST NOTICE is transmitted Jan. 10, 2001 12:15 PM. For example, if the NOTICE ADVANCE is fifteen minutes and the time to process is two minutes then the BROADCAST REQUEST must be received more than seventeen minutes before BROADCAST TIME.

It should be understood that the validation step 104 is preferred, but not required, for the invention.

### Production of the PUBLIC BROADCAST CONTENT

Referring to the example of FIG. 2, if step 104 validates the BROADCAST ALERT REQUEST then during the available time between it is received by the submitter central data interface 12 and the BROADCAST TIME the production resource 16 formats, at step 106, the CONTENT DATA into the form for broadcast as PUBLIC BROADCAST CONTENT. Formatting is generally necessary because the CONTENT DATA may include Microsoft Word®, HTML, XML files, and video files which are not in a form suitable for streaming data broadcast over the Internet, or as text for receipt by user's having, for example, Palm Pilot as their user receiving unit 18. In addition, the CONTENT DATA may contain hyperlinks to other web sites or descriptors for linking to additional content. The information from the other web sites, or corresponding to other links, must be combined with the CONTENT DATA and included in the PUBLIC BROADCAST CONTENT. The combination may done manually, or automatically, or both. All of the information, though, is identified by the hyperlinks in the CONTENT DATA, so all that is required is rote retrieval and input

It should be noted that step 106 can be omitted and, instead, the formats permissible for the BROADCAST CONTENT within the BROADCAST ALERT REQUEST limited such that, except for trivial reformatting, the PUBLIC BROADCAST CONTENT broadcast at step 112 is the BROADCAST CONTENT.

### Creating the NOTIFICATION LIST

While step 106 is formatting and assembling the PUBLIC BROADCAST CONTENT, step 108 searches the USER PROFILE DATABASE 8 using the INTEREST ITEMS as a template and generates a NOTIFICATION LIST reflecting all users who's USER PROFILE entries match entries in the INTEREST ITEMS of the BROADCAST ALERT REQUEST. The search is performed, for this example, using the general purpose programmable processor resource 10. If, for example, the INTEREST ITEMS contain the “XYZ Company” then the NOTIFICATION LIST is all USER PROFILE RECORDs having “the XYZ Company”in their PRIMARY ITEM or SECONDARY ITEM field.

### Generating and Transmitting the BROADCAST ALERT

Step 110 then generates a BROACAST ALERT having data identifying the INTEREST ITEMS, BROADCAST TIME DATA, and one or more BROADCAST SOURCE ADDRESS data. The BROADCAST SOURCE ADDRESS identifies the addresses at which the public broadcast will be available at the time indicated by the BROADCAST TIME data, which would be, for example, a URL address if the broadcast is over the Internet. The BROADCAST ALERT consists of, for example, a body of HTML XML, or similar transmission protocols with embedded link back information based on the BROADCAST PRIMARY ADDRESS, pointing to the Broadcast stream where the user may see the content at public release time.

Next, at step 112, a BROACAST ALERT is transmitted, by the broadcast resource 14 to each user identified in the NOTIFICATION LIST. For this example the notice broadcast resource 14 distributes via e-mail initially to an email application server (not shown), which then transmits to the users' e-mail enabled cellular phone/pager or other e-mail enabled devices constituting the receiving units 18. Apparatus and methods for transmitting e-mail text to e-mail enabled cellular phone/pagers are well known in the relevant arts and, accordingly, description is omitted. Additionally, BROADCAST ALERTs may be distributed via instant messaging systems, which are well known in the art, to users who are currently online and connected to the Internet. Once the BROADCAST ALERT has been transmitted a copy is archived in a separate data folder (not shown).

### Broadcast of the PUBLIC BROADCAST CONTENT

Next, referring to step 114 of FIG. 2, at BROADCAST TIME the PUBLIC BROADCAST CONTENT is broadcast or made available by the broadcast resource 16 over, for example, the Internet as a audio/video stream. The address at which the broadcast resource 16 makes the PUBLIC BROADCAST CONTENT available is the BROADCAST PRIMARY ADDRESS and, optionally, the BROADCAST SECONDARY ADDRESS that was contained in the BROADCAST ALERT earlier transmitted. The stream may be viewed by the user's receiving unit 20, via a web page with embedded player or via a custom player (not shown). Text streams will be available for users with cellular devices and other handheld devices that require a text only transmission format.

### Example of Constructing/Editing the USER PROFILE DATABASE

Referring to FIG. 2, in the preferred embodiment of the invention a user wishing to receive a BROACAST ALERT must first be registered in the USER PROFILE DATABASE, where “registration” means that a data record has been created and exists for the user, the data record having the USER ID, which is an identifier unique to the user, the USER SECONDARY DATA, the PROFILE ITEM list of the companies and other items for which the user wishes advance of notice of upcoming broadcast from or of broadcasts containing information about, and the USER CONTACT DATA, which identifies the means and address(es) by which the user wishes to be notified of such upcoming broadcasts.

The details of the user registration process itself are not key to this invention. An example, however, will be described in reference to FIGS. 3 and 4. For purposes of the example of FIGS. 3 and 4 the user accesses the central user data interface unit 6 by way of a web site (not shown) hosted on the unit 6, or hosted on another web server (not shown), or by e-mail.

Referring to FIG. 3, the example registration process begins at step 200 with the user, via the user remote data interface unit 4, visiting the web site (not shown) hosted by the central user date interface 6, and downloading an HTML form, such as the example form 30 of FIG. 4, having a plurality of data entry fields. The user accesses the web form using a web browser such as, for example Microsoft Internet Explorer® or Netscape Communicator®.

The user data entry operations are carried out by, for example, the above-identified personal computer (not shown) having Internet access through the FIG. 1 connection path 4c which, for example, may be by modem (not shown) and telephone line through an Internet Service Provider (ISP) such as America On Line®.

Next, referring to FIG. 3 and the example form of FIG. 4, at step 202 the user enters into the web form all information for the USER PROFILE, which for the example, is the user's name or other moniker and password, as USER ID, in the example field 32 of FIG. 3, labeled “Full Name”, enters as USER SECONDARY DATA his company name in field 34, labeled “Company”. The user then enters, as the USER CONTACT DATA for this example, his or her main e-mail address in field 36 and, for this example, enters into field 38 the user's e-mail enabled wireless device information

A general embodiment of this invention provides a form (not shown) in which the user enters one or more items of USER PROFILE data of his or her selection, which, for example, identify companies and other business entities of interest to the user. The USER PROFILE data may consist of stock exchange listings, separated by commas, identifying publicly traded companies such as IBM®, Intel®, and e-Bay®, or financial institutions, such as Bank of America®, investment advisor services, such as Merrill Lynch®, and business new services. Further, as identified above, the USER PROFILE may contain PRIMARY ITEMS and SECONDARY ITEMS, classed according to their interest value to the user.

Referring to FIG. 4, an alternate web form in accordance with this invention presents the user with a plurality of items 40, with a check box 42, instead of a data entry field in which the user types the PROFILE ITEMS. In the FIG. 4 example the user is presented with five companies, and those for which the user enters a mark in the check box 42 constitute the PRIMARY ITEMS for that user.

The FIG. 4 layout and arrangement of the web page form is for purposes of example only. The actual layout of the web page form is a matter of design choice, many variations of which are readily selected and implemented by one of ordinary skill in the art of web site design. The number and the type of fields describing the user is also for purposes of example only. Additional fields of information for describing the user is a design choice. For example, it is contemplated that the fields of a form such as the example of FIG. 4 could include geographical or financial information relating to the user. In addition, selected fields of the form, instead of being mandatory, may be filled out at the option of user, as is as is well known in the art.

Referring to FIGS. 3 and 4, when the user has completed entry of all PROFILE identifiers, the user clicks on the “submit” button 42 and, in response, the process goes to step 204 which verifies the completeness of the form and then to step 206 which stores the contents as a USER PROFILE within the USER PROFILE DATABASE 8. Software applications for transferring a web form to a public database are well known in the field of Internet business and, therefore, are not described.

FIG. 3 shows an optional step 208 wherein confirmation (not shown) is automatically sent to the user via e-mail if the information entered is complete and valid. An example check for validity compares the PRIMARY ITEMS and, optionally, the SECONDARY ITEMS entered by the user to the contents of the SUBSCRIBER DATABASE 9. If the user has entered a PRIMARY ITEM or a SECONDARY ITEM which is not in the SUBSCRIBER DATABASE then the e-mailed confirmation to the user would contain a text message such as, for example, “The company which you have entered as an item of interest is not registered in the system.” Procedures for sending e-mail confirmation of receipt of a sufficiently filled-out web form or mail server form, i.e., recognizable values into all required date entry fields, are well known in the art and, accordingly, will not be described.

An alternative to the web entry described above is that the user obtains an electronic form (not shown), via e-mail or from a portable disc or other media, fills in the fields in a manner substantially the same as described above for a web form, and sends the form via e-mail to a mail server (not shown) associated with or contain in the central user data interface 6. A mail server application (not shown) verifies the completeness of the form and, if it is complete, transfers it to the USER PROFILE DATABASE 8.

Referring to step 100 of FIG. 2 and to the example method for performing that step shown by FIG. 3, in constructing the USER PROFILE DATABASE 8 it should be understood that entry of the user information is not limited to the described text entry. Alternative methods include automated voice entry (not shown), wherein the new user telephones an automated operator service (not shown) and hears a sequence of synthesized voice prompts requesting the user to state, by voice, information such as that shown at FIG. 4. Methods of automated voice entry are well known in the art, and commercial systems for such are available from numerous vendors. Another alternative is that the user telephones or e-mails a third party who then, using a data entry method such as described above, enters the information into the USER PROFILE DATABASE 8

### Web Form BROADCAST ALERT REQUEST Submission

The above-described example submission of a BROADCAST ALERT REQUEST was via e-mail. Alternatively, the submitter, which may be a public relations (PR) firm or a PR representative of a company, populates a web server application based form (not shown) with the above-identified ALERT DATA and CONTENT DATA information content of the BROADCAST ALERT REQUEST. The web form is hosted on, for example, the central submitter data interface 12. The web server application creates an immediate destination e-mail message with a specified subject string having the ALERT DATA. As described above, the ALERT DATA establishes the companies or items mentioned, the time to release the information and the type of the item submitted.

The email message, corresponding to the ALERT DATA is written to a mail server local to the web server hosting the web form. The CONTENT DATA having, for example, the body of a press release is included. The web form method for receiving BROADCAST ALERT REQUESTs avoids the time delay for Internet submission of e-mail, which may occur using the above-described e-mail method for submitting BROADCAST ALERT REQUESTs. In addition, this mechanism and improves the reliability of the BROADCAST ALERT REQUEST transmission. For example, in the event the web server hosting the web form is not reachable via external means (Internet), the submitting company may contact the entity hosting the web site telephone to create the request via manual process.

### Further Embodiments

The above-described example user registration step 100 does not place any limitation on the USER PROFILE data, or on its optional PRIMARY ITEMS and SECONDARY ITEMS. A further embodiment of the invention stores at the user central data interface 6 a SUBSCRIBER DATABASE 9, which is a list of ACCEPTABLE PRIMARY ITEMS and, as a further option, a list of ACCEPTABLE SECONDARY ITEMS representing the current universe of PRIMARY ITEMS and, optionally, SECONDARY ITEMS that the system will recognize. The purpose of the SUBSCRIBER DATABASE is to limit notice broadcasts to PRIMARY ITEMS and/or SECONDARY ITEMS to those associated with entities who have subscribed to broadcast through the system of this invention.

A still further embodiment of this invention provides the user with direct control over the receiving the notice of upcoming broadcast at a time in advance of the broadcast, which is a major feature of this invention, or at the time the broadcast starts. It is contemplated by this invention that some users may wish such an option. More particularly, a user interested in a large number of PRIMARY ITEMS may find himself or herself receiving a plurality of notices within a short period of time, each indicating that a broadcast corresponding to a PRIMARY ITEM within, for example, the next ten minutes. Such a user may then have a difficulty in remembering the upcoming broadcast and, as a result miss at least the beginning. An optional feature of this invention avoids such situations by providing the user with an IMMEDIATE NOTICE selection box on the web registration form. To enable this feature, the notice transmittal step, as described below, transmits a first notice to all users whose PRIMARY ITEMS or SECONDARY ITEMS match items of interest in the upcoming content broadcast and who did not check IMMEDIATE NOTICE for those items. The notice transmittal step, as described below, then transmits a second notice to all users whose PRIMARY ITEMS or SECONDARY ITEMS match items of interest in the upcoming content broadcast and who did check IMMEDIATE NOTICE for those items.

It is to be understood that the present invention is described above in reference to specific embodiments, which are for purposes of example only, and that the invention is not limited to the specific arrangement, or configuration described hereinabove or shown in the drawings, but also comprises the various modifications readily apparent to one skilled in the art upon reading this specification, as defined by the broadest scope of the appended claims.

What is claimed is

1. A method comprising steps of:
receiving a plurality of user profile records, each user profile record having a user identifier data and a user key word data;
storing said plurality of user profile records in a database;
receiving a first broadcast data having a content data, a notification header, the notification header having a submitter key word data, and a broadcast time data;
comparing said submitter key word data to the user key word data of said stored plurality of user profile records;
identifying a matching user profile record based on said comparing;
generating a notification data based on said comparing, said notification data having a notice subject data representing a result of said comparing, and a notice broadcast time data based on said broadcast time data;
transmitting, at a first time, a user notification signal to a receiving address based on the user identifier data of said matching user profile record;
broadcasting a content data stream corresponding to said content data at a second time, said second time corresponding to said broadcast time data.

2. A method according to claim 1 further including the step of generating a broadcast source address data, and wherein
said notification data includes said broadcast source address data, and
said broadcasting is via a network having an addressable source protocol, and said broadcasting is based on said addressable source protocol and said broadcast source address data.

3. A method according to claim 2, wherein
the step of generating a broadcast source address data further generates an alternate broadcast source address data,
the step of transmitting the user notification data transmits the alternate broadcast source address data, and
wherein said broadcasting step includes broadcasting a primary second broadcast data over a network having a source address protocol, from a first source corresponding to said broadcast source address data, and includes broadcasting an alternative second data stream from a second source corresponding to said alternate broadcast source data

4. A method according to claim 1 wherein the second time is subsequent to the first time by a predetermined notice time.

5. A method according to claim 4 further comprising steps of:
receiving a subscriber source identifier with said first broadcast data;
calculating a difference between said first time and said second time;
comparing the calculated difference to a time qualification data representing said predetermine notice time;
transmitting a broadcast acceptance signal to an address based on said subscriber source identifier based on a result of said comparing.

6. A method according to claim 1 wherein the broadcast content data contains a reference data identifying additional broadcast content and further comprising the step of retrieving the additional broadcast content during the time interval between said first time and said second time.

7. A method according to claim 1, further comprising a step of receiving a notice time preference data associated with said user key word data, and wherein said first time is based on said notice time preference data.

8. A method according to claim 1, further comprising steps of:
receiving a notice time preference data associated with said user key word data;
generating a second notification data based on said comparing, said second notification data having a notice subject data representing a result of said comparing, and a notice broadcast time data based on said broadcast time data; and
transmitting, at a third time, a second user notification signal to a receiving address based on the user identifier data of said matching user profile record.

9. A method according to claim 1, further comprising steps of:
constructing a database of acceptable user key words;
comparing the user key word of one or more of said received plurality of user profile records to said database of acceptable user key words;
generating a key word acceptance data based on said comparing; and
transmitting a key word signal, based on said key word acceptance data, to an address based on said user identifier data.
